(19) United States
(12) Patent Application Publication
(10) Pub. No.: US 2015/0000571 A1
(43) Pub. Date: Jan. 1, 2015

(54) PORTABLE LOCK BOX

(71) Applicant: Adie, LLC, Cleveland, OH (US)

(72) Inventor: Adrienne Stemen, Cleveland, OH (US)

(73) Assignee: Adie, LLC, Cleveland, OH (US)

(21) Appl. No.: 14/268,233

(22) Filed: May 2, 2014

Related U.S. Application Data
(60) Provisional application No. 61/840,092, filed on Jun. 27, 2013.

(51) Int. Cl. E05G 1/00; E05G 1/026; E05G 1/04

(52) U.S. Cl. CPC E05G 1/005; E05G 1/04; E05G 1/026
USPC 109/23; 109/59 R; 109/52

(57) ABSTRACT

A portable lock box having a bin and hangers can be connected to a variety of articles, such as the underside of a beach chair or a picnic table. The portable lock box may include a lid with vents, a screen, a window, display, etc. In addition, the portable lock box may include a locking mechanism that is removable, rechargeable, and can be overwritten using a master passcode and/or key.

### CROSS REFERENCE TO RELATED APPLICATION

This application claims priority to U.S. provisional application no. 61/840,092, filed Jun. 27, 2013, which is herein incorporated by reference in its entirety.

### FIELD

This disclosure relates to a portable lock box. The lock box contains a locking mechanism for securing items therein, and a hanger for attaching the lock box to an article, such as a lounge chair. More specifically, the locking mechanism and hanger are removably attached to the lock box.

### BACKGROUND OF THE INVENTION

Storing valuable items in a locked container, such as a lock box or safe, is often times useful during certain activities. For example, an individual may have an interest in protecting valuable items that are not in use while at a beach, pool, picnic, amusement park, or camp site. Although an amusement park or beach may be equipped with lockers located at its entrance or other designated location, such lockers are undesirable because of its inconvenient placement, unclean interior, and limited protection against theft. An individual may be concerned about easily accessing their items in a quick and convenient manner, preventing loss or theft of their most valuable items, and protecting their items from water, wind, sun, and other potentially damaging sources.

An example of a portable safe may be seen by reference to U.S. Patent Application Publication No. 2012/0298018, the disclosure of which is hereby incorporated by reference. Even in the case of portable locking devices, such as a portable safe, an individual must bring their own safe with them to a location. Given the mobility of modern travel, there is a need for a lock box that can be acquired on-site, that has a separable locking device and holding container for quick cleaning, potential re-use, and containment of an individuals' personal belongings. Also, there is a need for easy disassembly, cleaning, and re-assembly of a lock box.

Although lockers may generally provide a solution to protecting items from loss or theft, there are several drawbacks to using such lockers. For example, lockers are commonly located in inconvenient locations, require rental fees, lockers may be unclean from prior use by another consumer, lockers may also be out of the consumer's sight, and difficult to relocate. Additionally, it may be burdensome to travel to the locker location, and may require an individual to remember a passcode or hold on to a key to re-open the locker. It is also desirable to have a locking device capable of streamlined attachment to furniture or other generally immobile structures. Thus, there is still a need for alternative locking apparatus and methods.

### BRIEF DESCRIPTION OF THE DRAWINGS

The present disclosure may be better understood by reference to the following detailed description taken in connection with the following illustrations, wherein:

FIG. 1 illustrates an exemplary embodiment of an exploded view of a lock box;

FIG. 2 illustrates an exemplary embodiment of a hanger;

FIG. 2B illustrates an exemplary embodiment of a hanger;

FIG. 3 illustrates an exemplary embodiment of a closed lock box;

FIG. 3B illustrates an exemplary embodiment of a partially open lock box;

FIG. 4 illustrates an exemplary embodiment of several stacked bins;

FIG. 5 illustrates an exemplary embodiment of a lock box connected to a lounge chair; and

FIG. 5B illustrates an exemplary embodiment of a lid connected to a lounge chair.

### DETAILED DESCRIPTION

Reference will now be made in detail to embodiments of the disclosure, examples of which are illustrated in the accompanying drawings. It is to be understood that other embodiments may be utilized and structural and functional changes may be made without departing from the respective scope of the disclosure.

Securement of valuable items can be achieved by using a portable lock affixed to a container, such as a box or bin. In particular, a portable lock allows for mobility and use in a variety of circumstances. A removable, portable lock in conjunction with a holding container, such as a bin, allows for reuse of the portable lock and holding container. Although a portable lock is primarily referred to with respect to a box or bin, this disclosure also relates to other containers.

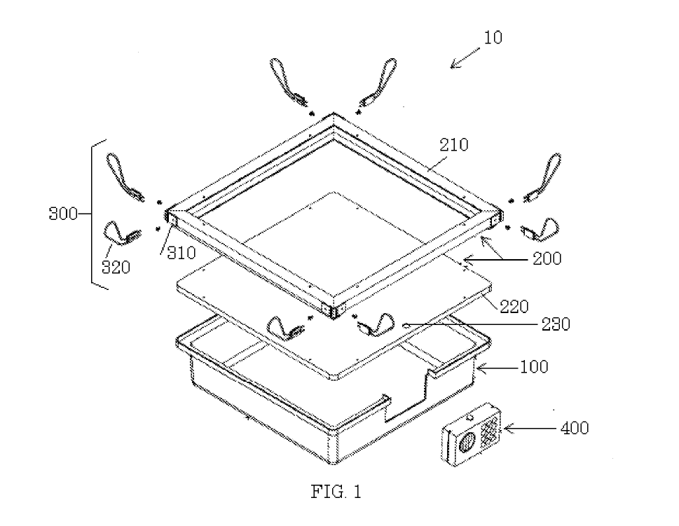

With reference to FIG. 1, an exploded view of a portable lock box 10 is depicted. The portable lock box 10 generally includes a bin 100, lid 200, hanger 300, and locking mechanism 400.

Bin 100 is used to contain articles for storage. For example, articles such as eyewear, cellular devices, laptops, or wallets can be stored in bin 100. In FIG. 1, bin 100 is depicted as a substantially rectangular shape, however, bin 100 can be selected from any suitable shape, such as rectangular, curvilinear, rounded, any combination thereof, etc. In an embodiment, bin 100 can be fitted and/or stacked with other bins for space-saving measures and/or ease of portability.

Use of a portable lock box 10 at a beach or other outdoor settings can cause bin 100 to become dirtied easily. Therefore, bin 100 can be chosen from suitable materials that are easily cleaned. For example, bin 100 may be selected from any one or a combination of the following materials: plastic, metal, foam, bamboo or other natural materials, or a combination of two or more thereof. In addition, bin 100 may optionally be theft-resistant, shred-resistant, waterproof, fire resistant, LTV and/or sun resistant, antimicrobial, and/or insulated. Bin 100 may optionally be equipped with a tracking device. Cleaning may optionally be achieved by liquid washing, disinfecting using sterilizing agents, light therapy cleaning, and other known methods.

For example, bin 100 may be insulated to protect articles held therein from excessive sun, wind, or other elements. An insulated material may be used to form the bin itself or provided as an insert for the bin to allow an individual to store items therein. Beneficial uses of an insulated lock box include storage of medicine, food, snacks, cosmetics, sunscreen, or other products that can be altered or harmed by sun exposure. Optionally, bin 100 may include a temperature gauge or other temperature display device, such as a color-coded temperature indicator, for example.

Optionally, bin 100 may have feet to protect the bottom of the bin when it is placed on another surface. Bin 100 may optionally include vents of suitable size and shape. Bin 100 may optionally include a tracking device for safety and/or relocation means. Optionally, bin 100 may be adorned with advertisements, a company's logo or other indicia, a window, a screen for displaying information, etc. As further illustrated in FIG. 1, bin 100 has a lid 200. Bin 100 can be separated from the lid 200 by pulling bin 100 in an outwardly direction.

Lid 200 is used to primarily cover bin 100 when the lock box is closed. Lid 200 is comprised of a lid frame 210 and a lid cover 220. Lid cover 220 may further include a locking aperture 230.

Generally, lid 200 is sized to fit bin 100. Lid 200, similar to bin 100, can be formed of any suitable material, such as plastic, metal, foam, bamboo or other natural materials, or a combination of two or more thereof. Lid 200 can be a flexible material or a relatively hard material. For example, it may be beneficial to use a flexible material for the lid 200 because if an individual attaches a lock box 10 to the bottom of a chair, then the lid 200 may conform to the shape of the seat as the individual sits on the chair. In an embodiment, the lid 200 may be formed of an impenetrable mesh material.

Lid frame 210 and lid cover 220 may be formed of two individual parts, as illustrated in FIG. 1. Alternatively, lid frame 210 and lid cover 220 may be formed of a single unitary piece.

In an embodiment, bin 100 and/or lid 200 are formed of collapsible materials. For example, the bin 100 and/or lid 200 are formed of pliable materials capable of folding down and collapsing. In an embodiment, the bin 100 and/or lid 200 are selected from perforated materials. In yet another example, bin 100 and/or lid 200 are formed of either pliable or rigid materials, and are collapsible along at least one seam. In an embodiment, the seams are formed of elastomeric materials suitable for folding and bending, yet the seams are capable of maintaining its durability when exposed to sun, wind, and rain. In yet another embodiment, bin 100 and/or lid 200 are formed of disposable materials.

In an alternative embodiment, the lock box 10 can be secured without the use of a lid 200. For example, bin 100 may be placed substantially flush under an object that can receive bin 100 and protect articles being held in bin 100. As an example, the object may be a chair, table, etc. In an alternative embodiment, bin 100 may be formed of a sack or bag, therefore possibly alleviating the need for a lid 200.

Lid 200 may optionally be affixed with grips, vents, a tracking device, advertisements, logos or other indicia, a window, a screen for displaying information, etc.

A locking aperture 230 receives a locking mechanism 400, such as a locking bolt therethrough. A locking aperture 230 may be located at a variety of locations. For example a locking aperture 230 may be located on the lid 200. More particularly, in an embodiment, the locking aperture 230 is located on lid frame 210. In an alternative embodiment, the locking aperture 230 is located on lid cover 220. In yet another embodiment, the locking aperture 230 is located on a combination of both of the lid frame 210 and lid cover 220. In an embodiment where a lid 200 is not used with the bin 100, a locking aperture may be located on another object, such as a chair, a table, or bin 100.

At least one hanger 300 is useful in connecting the lock box 10 to other objects. In FIG. 1, four hangers 300 are shown connected to lid 200. Any suitable number of hangers 300 can be utilized. Hanger 300 is comprised of a hanger holder 310 and at least one wire hanger 320.

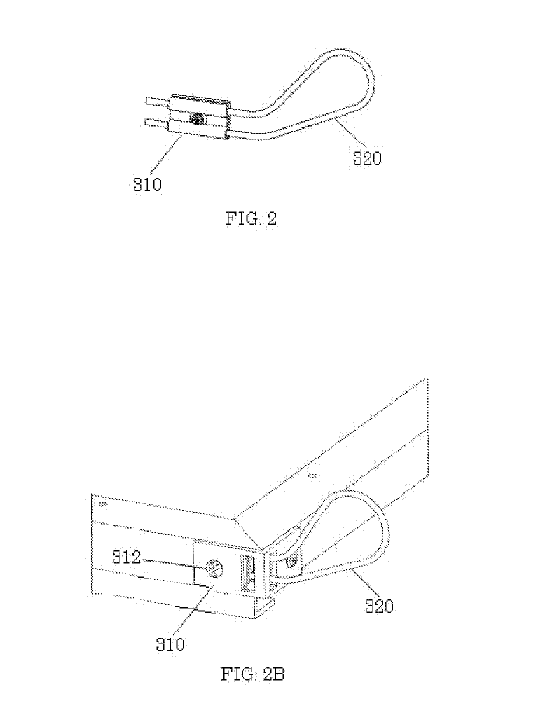

A hanger holder 310 is used to secure the hanger to the lock box 10. Examples of hanger holders are depicted in FIGS. 2 and 2B. In FIG. 2, the hanger holder 310 is generally a clamp with a screw and apertures for receiving the wire hanger 320. In an alternative embodiment, the screw may be replaced with other known fastening means. Furthermore, the number of apertures in FIG. 2 can alternatively be one aperture or any suitable number greater than one. In FIG. 2B, the hanger holder 310 is a frame having an L-shape with a security screw 312. Security screw 312 can be used to clamp down on the hanger 300. Alternatively, the security screw 312 can be replaced with other suitable securing and/or fastening means.

At least one wire hanger 320 is used in connection with the hanger holder 310 to aid in hanging or otherwise attaching the lock box 10 to an article. The wire hanger 320 can be measured, cut to length, and inserted into the hanger holder 310. The wire hanger 320 may be hollow, solid, or a mix of both. In an embodiment, the wire hanger 320 is coated with suitable materials and/or cut-resistant. In an embodiment, the wire hanger 320 is flexible, rigid, or a mix of both. In an embodiment, the wire hanger 320 is rust-resistant, heat-resistant, water-resistant, or a combination thereof. The wire hanger 320 may be selected from any suitable shape, size, or color. For example, a wire hanger 320 can be selected from suitable materials such that wire hangers 320 are hung from slats on a lounge chair or picnic table.

Furthermore, any suitable number of wire hangers 320 may be used. A suitable number may be chosen based on the size, weight, shape, and purpose of the lock box 10. However, other factors may come into play when determining the appropriate number of wire hangers 320 desired. Generally, in the figures, four wire hangers 320 are illustrated merely as an exemplary embodiment.

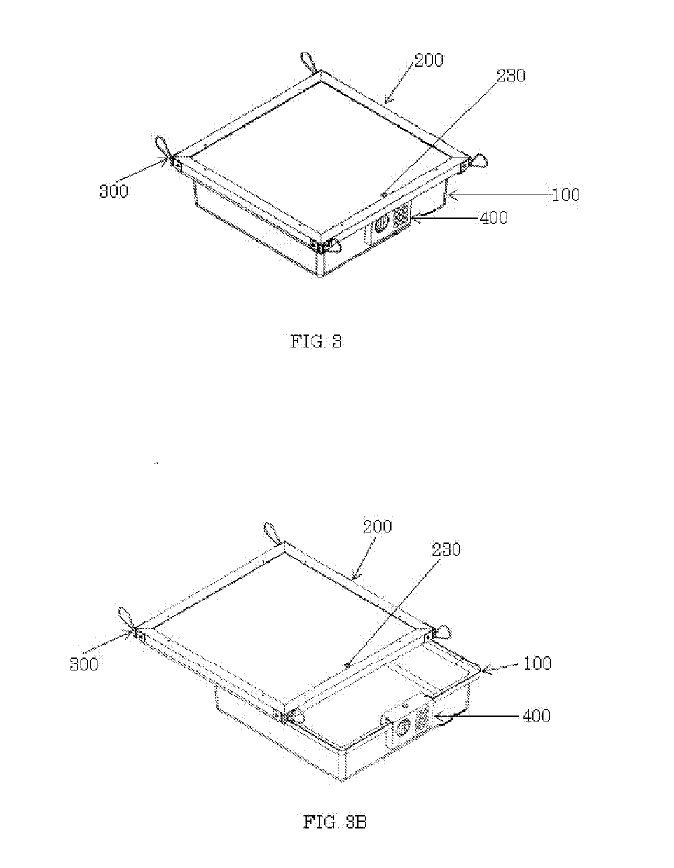

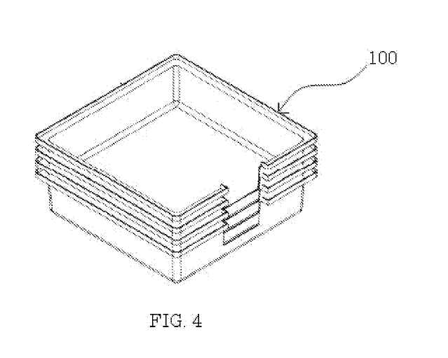

FIGS. 3 and 3B illustrate the lock box 10 in different positions, namely a closed position in FIG. 3 and a partially open position in FIG. 3B. FIG. 4 illustrates several bins 100 stacked together.

A locking mechanism 400 is used to lock the lock box 10. A grooved portion of the locking mechanism 400 fits directly with bin 100. The locking mechanism 400 is removable and rechargeable. The locking mechanism 400 may optionally includes a keypad module 410 and a dial 420.

The locking mechanism 400 can include any suitable locking device, such as a bolt device, a snap device, a screw device, a pin device, a magnetic device, a C shaped rod, a grasping lock device, etc. Locking mechanism 400 may have any suitable power supply. For example, the locking mechanism 400 may be re-charged by an electrical power, solar power, a combination thereof, etc. In an alternative embodiment, the locking mechanism 400 may be programmed to operate for a predetermined period of time. In an alternative embodiment, the locking mechanism 400 is connectable to a battery charging station containing an AC plug.

A keypad module 410 allows an individual to set a passcode for lock box 10. In an embodiment, the keypad module 410 may include numeric digits, such keys from 0-9, alphabetical digits, such as keys from A-Z, other known symbols, such as keys containing ‘$’, ‘*’, and ‘#’, or a combination thereof. In an alternative embodiment, the keypad module 410 is a fingerprint scan and/or eye scan. In an embodiment, the keypad module 410 has an overmolded keypad with backlit controls. Other suitable keypads may be selected for the keypad module 410, such as those keypads that are easily cleaned, stay cool to the touch in hot temperatures, and are easily visible in the day time and night time. Optionally, the locking mechanism 400 may be equipped with a GPS and/or locating device. In an embodiment, the locking mechanism 400 may be electronic, mechanical, and or a combination thereof.

In an embodiment, keypad module 410 may be overridden. For example, in the case that the passcode for opening the keypad module 410 is unavailable, a master code or other lock overwriting mechanism, can be used to with the keypad module 410 to open the lock box 10.

A dial 420 is optionally included on the lock box 10. Dial 420 can be used as a handle to aid in unlocking the lock box 10. In an embodiment, dial 420 may be used as a rotatable dial for unlocking the locking mechanism 400. Dial 420 is generally depicted as having a circular shape, however, the dial 420 may be selected from any suitable shape or size. In an alternative embodiment, dial 420 may represent a dial, logo, light, name tag, or any combination thereof.

The grooved portion of the locking mechanism 400 essentially retains the locking mechanism 400 on the bin 100. For illustrative purposes, an example will be described where the lock box 10 is available for rental at a poolside resort. A resort owner may rent a lock box 10, namely, a bin 100, lid 200, and/or locking mechanism 400 to an individual for attachment to the bottom of a lounge chair. The individual can connect the lock box 10 to the bottom of his or her chair and retain valuable objects inside the lock box 10. Afterwards, the individual can return the lock box 10 back to the rental area or leave the lock box 10 secured to the chair for the owner to recollect. The resort owner can remove the locking mechanism 400 for recharge at a battery recharging station. Then the bin 100 can be cleaned, optionally dried, and stacked with other bins 100. The lid 200 can also be cleaned, optionally dried, and stacked with other lids 200. In an embodiment, bin 100 and/or lid 200 can be attached to the bottom of a lounge chair, or other article, and the lounge chair can be stacked with others chairs.

The use of grooves on the body of the locking mechanism 400 allows an individual to easily secure and remove it from bin 100. In an alternative embodiment, bin 100 contains grooves or fitments to provide additional connection and securement with the locking mechanism 400.

In an embodiment, the grooved portion of locking mechanism 400 is selected from 0.1 to 5 inches in depth, and traverses a width of 0.1 inch up to the entire width of the lock box 10. In another embodiment, the grooved portion has a depth of 0.5 to 2 inches, and a width of 0.5 to 2 inches. In an embodiment, the grooved portion is slot-shaped having a substantially rectangular, triangular, perforated, rounded, or other suitably selected shape.

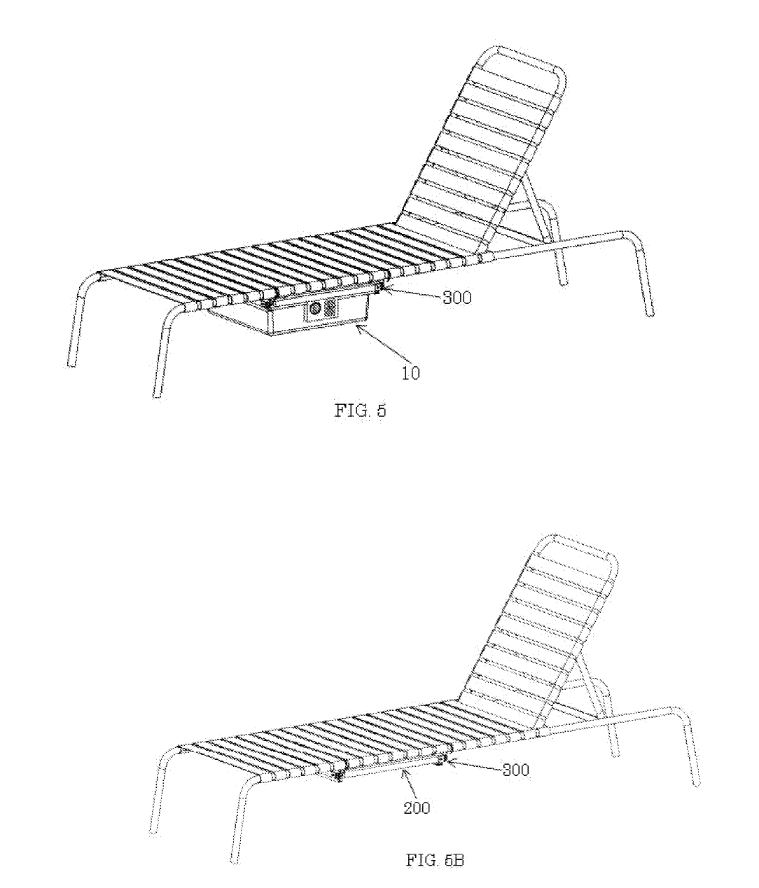

FIG. 5 illustrates a lock box 10 attached to the bottom of a lounge chair. FIG. 5B illustrates a lid 200 of lock box 10 attached to the bottom of a lounge chair. As an example, a resort owner may keep parts of the lock boxes 10 affixed to the lounge chairs. Therefore the owner may rent out only the bin and lock, or only the lock, and the individual can connect these pieces with other pieces already attached to a lounge chair, to form an entire lock box 10 assembly.

FIGS. 1-5B illustrate non-limiting exemplary embodiments of the portable lock box. Other examples of locations for placement of a lock box may be envisioned. Those skilled in the art will readily appreciate that changes and/or modifications may be made thereto without departing from the spirit and scope of the subject disclosure.

Other functionally inconsequential additives or steps may also be included without departing from the principles of this disclosure. While these articles expressly cover all foreseeable equivalents of the elements recited above, additional variations are possible. For example, it is possible to include a remote control or keyless push start that is optionally waterproof and/or capable of floating in water, for opening the locking mechanism of the portable lock box.

The foregoing detailed description has been given for clearness of understanding only and no unnecessary limitations should be understood therefrom as some modifications will be obvious to those skilled in the art without departing from the scope and spirit of the appended claims.

We claim:

1. A lock box comprising:
a bin;
a lid; and
a locking mechanism removably attached to the bin for locking the bin to the lid.

2. The portable lock box of claim 1, wherein the locking mechanism includes a rechargeable battery source.

3. The portable lock box of claim 1, further comprising insulation.

4. The portable lock box of claim 1, further comprising a temperature gauge or temperature display.

5. The portable lock box of claim 1, further comprising a tracking device.

6. The portable lock box of claim 1, wherein the lid comprises an impenetrable mesh material.

7. The portable lock box of claim 1, wherein the bin is collapsible to a smaller size.

8. The portable lock box of claim 1, wherein the lid includes at least one of the following: at least one grip, at least one vent, a window, and a screen.

9. The portable lock box of claim 1, wherein the locking mechanism connects to a locking mechanism formed on the lid.

10. The portable lock box of claim 9, wherein the locking mechanism includes a grooved portion that fits directly with the bin.

11. The portable lock box of claim 9, wherein the locking mechanism is removable and includes a GPS.

12. The portable lock box of claim 9, wherein the locking mechanism is rechargeable via solar power.

13. The portable lock box of claim 9, wherein the locking mechanism is programmed to operate for a predetermined period of time.

14. The portable lock box of claim 1, further comprising at least one hanger.

15. The portable lock box of claim 14, wherein the portable lock box has four hangers located at the periphery of the portable lock box.

16. The portable lock box of claim 1, wherein the bin is stackable with at least one other bin, and the lid is stackable with at least one other lid.

17. The portable lock box of claim 1, further comprising a portable keypad.

18. A portable lock box comprising:
a bin; and
a locking mechanism having a grooved portion for fitment with the bin, wherein the locking mechanism include a keypad.

19. The portable lock box of claim 18, further comprising a lid.

20. A portable lock box comprising:
a bin;
a lid;
at least one hanger; and
a locking mechanism.
